(19) United States
(12) Patent Application Publication
(10) Pub. No.: US 2014/0136171 A1
(43) Pub. Date: May 15, 2014

(54) Unstructured Grids For Modeling Reservoirs

(71) Applicants: Charles Hege Sword, JR., Danville, CA (US); Thomas Lucas Viard, Walnut Creek, CA (US); Bradley Thomas Mallison, Santa Clara, CA (US)

(72) Inventors: Charles Hege Sword, JR., Danville, CA (US); Thomas Lucas Viard, Walnut Creek, CA (US); Bradley Thomas Mallison, Santa Clara, CA (US)

(73) Assignee: Chevron U.S.A. Inc., San Ramon, CA (US)

(21) Appl. No.: 13/826,768

(22) Filed: Mar. 14, 2013

Related U.S. Application Data
(60) Provisional application No. 61/725,906, filed on Nov. 13, 2012.

(51) Int. Cl. G06F 17/50

(52) U.S. Cl. CPC G06F 17/5009
USPC 703/10

(57) ABSTRACT

An earth model of a subsurface reservoir having an unstructured tetrahedral grid defining a plurality of tetrahedral cells that conform to geological discontinuities is provided. The tetrahedral cells define vertices in a physical space that store information associated with a depositional space of the subsurface reservoir. A polyhedral grid is generated in the physical space from the unstructured tetrahedral grid. The polyhedral grid defines a plurality of polyhedral cells that are split based on the information associated with the depositional space. One or more of the plurality of polyhedral cells can be associated with one or more elements having split-property values that correspond to properties on opposite sides of the one or more geological discontinuities. The polyhedral grid is used to model the behavior of the subsurface reservoir.

### CROSS-REFERENCE TO A RELATED APPLICATION

The present application for patent claims the benefit of U.S. provisional patent application bearing Ser. No. 61/725,906, filed on Nov. 13, 2012, which is incorporated by reference in its entirety.

### TECHNICAL FIELD

The present invention generally relates to a method, system and processor readable medium containing computer readable software instructions for reservoir gridding, and more particularly for generating a polyhedral grid used for modeling the behavior of a subsurface reservoir.

### BACKGROUND

Reservoir simulation involves the numerical solution of a system of equations that describes the physics governing the complex behaviors of multi-component, multi-phase fluid flow in the naturally porous media of a subterranean reservoir. The system of the equations is typically in the form of coupled nonlinear partial differential equations (PDE's). The PDE's are discretized in time and space on a given grid, and discrete equations are solved, such as by an iterative process, for a series of time steps until a prescribed time is reached. At each time step, linearization of the nonlinear system of equations (e.g., Jacobian construction), solving the linear system, and computing a subsequent system of equations is performed. A display representing the fluid flow in the reservoir being modeled can be generated using the simulation results at each time step. Reservoir simulation is widely used in the petroleum industry to model (e.g., analyze, forecast, simulate) the behavior of fluid flow in hydrocarbon bearing subterranean reservoirs, such as gas or oil fields. For instance, simulation inputs can be varied for a reservoir model to project how certain changes might influence a reservoir's future performance. The simulation results are typically used for making reservoir management decisions, such as whether to develop new reservoir fields or how to efficiently manage production of current fields.

The starting point for reservoir simulation is reservoir gridding. Reservoir gridding can be described as the process of decomposing a 3D reservoir volume into a plurality of smaller and simpler 3D volumes, which are typically referred to as cells, finite volumes, control volumes, or finite elements depending on the discretization and simulation techniques being utilized. Accordingly, reservoir gridding techniques break a continuous domain into discrete counterparts that can subsequently be used to construct a simulation model by discretizing the equations describing fluid flow, geomechanics, or a combination thereof. In other words, a grid (structured or unstructured) is imposed upon an area of interest in a reservoir or earth model to define a plurality of cells (e.g., non-overlapping polyhedral cells), each having one or more unknown properties associated therewith, that approximate the shape and geometry of the reservoir. The unknown properties serve to characterize the reservoir and can include, but are not limited to, fluid properties such as pressure, temperature or water saturation, and rock properties such as permeability or porosity.

Grid generation has been recognized for many years as being one of the most challenging problems in reservoir simulation. Corner-point grids remain the industry standard both for reservoir flow simulations and earth modeling frameworks. There are several challenges and limitations that arise when applying corner-point grids to reservoirs with nontrivial structure. The usual approach is to first construct a 2D curvilinear grid based on a chosen horizon such that the grid coordinate lines are distorted to honor the faults. As an alternative, the faults can be approximated using stair-stepped geometry. This 2D grid is then extruded in the third dimension along pillars that are aligned with faults. The implicit {i,j,k} indexing of a corner-point grid is used to derive geologic distances that inform geostatistical property modeling. When faults are not vertical, pillar distortions introduce bias into geostatistical algorithms and can induce errors for flow simulations. The process of building a corner point grid becomes challenging if multiple intersecting faults (e.g., more than a dozen) are included. More severe limitations arise if the fault network includes truly 3D features such as y-faults. In these cases, the pillar concept breaks down entirely and serious compromises must be made. Non-vertical faults are either forced to be more vertical, or some faults must simply be removed. The errors induced by these structural simplifications cannot generally be quantified in flow simulation studies. However, of even greater concern is the fact that these alterations become a major impediment to integrated modeling efforts and interdisciplinary collaboration.

A new gridding tool is needed that improves the accuracy and performance of upscaling and flow simulation, preserves truly 3D features of geologically consistent earth models, and enhances usability and workflow efficiency.

### SUMMARY

A method, system and processor readable medium containing computer readable software instructions are disclosed for generating a polyhedral grid used to model the behavior of a subsurface reservoir. An earth model of the subsurface reservoir having an unstructured tetrahedral grid defining a plurality of tetrahedral cells that conform to one or more geological discontinuities is provided. The tetrahedral cells define vertices in a physical coordinate system that store information associated with a depositional space of the subsurface reservoir (e.g., time of deposition and geographic locations at the time of deposition). A polyhedral grid is generated in the physical space from the unstructured tetrahedral grid. The polyhedral grid defines a plurality of polyhedral cells that are split based on the information associated with the depositional space. One or more of the plurality of polyhedral cells can be associated with one or more elements (e.g., vertices, edges, contact polygons) having split-property values that correspond to depositional properties on opposite sides of the one or more geological discontinuities. Elements that are adjacent to one or more geological discontinuities can have multiple sets of properties such that each set of properties correspond to properties on opposite sides of the geological discontinuity. The polyhedral grid is used to model the behavior of the subsurface reservoir.

In embodiments, polyhedral cells positioned away from geological discontinuities are typically hexahedral, substantially orthogonal, arranged in a structured manner, and have been refined or coarsened.

In embodiments, the polyhedral grid is generated by converting the unstructured tetrahedral grid to a polyhedral data structure. Here, the polyhedral grid comprises a plurality of polyhedral cells that correspond to the tetrahedral cells of the unstructured tetrahedral grid. Vertices and polygons of the plurality of polyhedral cells that are co-located are welded while preserving split-property values. One or more of the plurality of polyhedral cells are split along an iso-value surface associated with the depositional space of the subsurface reservoir. Adjacent polyhedral cells that share the same discrete {u,v,w} values are merged to form the polyhedral grid used to model the behavior of the subsurface reservoir. In embodiments, the polyhedral grid can further be updated by merging cells that are too small or otherwise deemed undesirable.

In embodiments, an unfolded and unfaulted Cartesian grid, which is associated with the depositional space of the subsurface reservoir and defines a plurality of Cartesian cells in a depositional coordinate system, is generated. The tetrahedral cells of the unstructured tetrahedral grid are intersected with the Cartesian cells to produce a plurality of polyhedral cells, thereby producing the polyhedral grid. The polyhedral grid can be updated by merging two or more of the plurality of polyhedral cells (e.g., adjacent cells in the polyhedral grid that originate from a common Cartesian cell, cells that are too small or otherwise deemed undesirable) and forming contact polygons between pairs of polyhedral cells that are adjacent to geological discontinuities. In embodiments, two or more of the contact polygons shared by a given pair of polyhedral cells are also merged with one another.

In embodiments, anisotropic cell splitting (refinement) or merging (coarsening) operations are applied to the Cartesian grid prior to generating the polyhedral grid. In embodiments, splitting and refining operations based on isovalues can also be carried out to further update the polyhedral grid.

In embodiments, forming contact polygons between polyhedral cells that are adjacent to the one or more geological discontinuities comprises grouping polyhedral cells that are on opposite sides of the one or more geological discontinuities and modifying the faces of the polyhedral cells to reflect this grouping. For example, a welding operation can be performed where:
(1) interfaces of the polyhedral cells associated with the one or more geological discontinuities are projected onto coordinate planes of a physical coordinate system {x,y,z};
(2) edges of the polyhedral cells are projected onto the coordinate lines of the physical coordinate system {x,y,z};
(3) segments are formed that honor the interfaces of the polyhedral cells associated with both sides of the one or more geological discontinuities, the segments being formed based on the relative position of vertices associated with edges of the interfaces and by computing intersection points interior of the interfaces where edges intersect such that the intersection points define end points for the segments; and
(4) forming the contact polygons utilizing at least one of the segments.

### BRIEF DESCRIPTION OF THE DRAWINGS

FIG. 1 illustrates an example of an unstructured cut-cell grid.

FIG. 2 illustrates a schematic of a depositional property at vertices across a fault.

FIG. 3 illustrates a method for generating a grid used for modeling the behavior of a subsurface reservoir.

FIG. 4 illustrates an embodiment for generating a polyhedral grid.

FIG. 5 illustrates an embodiment for generating a polyhedral grid.

FIG. 6 is a 2D illustration depicting the transformation from physical space (top) to depositional space (bottom) that is used to generate cells that are cut by faults.

FIGS. 7A-7D illustrate steps involved in a welding process.

FIG. 8 illustrates contact polygons computed by a welding process.

FIGS. 9A-9C illustrate examples of exceptional polyhedra.

FIGS. 10A-10C illustrate adjacency relationships for halfedges.

FIG. 11 illustrates a schematic of a compressed data structure for a single polyhedron.

FIG. 12 illustrates the results of compressing several example grids.

FIG. 13 illustrates a system for generating a grid used for modeling the behavior of a subsurface reservoir.

FIGS. 14A and 14B compare a cut-cell grid (14A) and a vertically stair-stepped grid (14B) for a model containing a y-fault.

FIG. 15 illustrates an example of a cut-cell grid with overturned stratigraphy.

FIGS. 16A-16C illustrate an example for a synthetic model containing several non-conformities.

FIGS. 17A-17C illustrate flow diagnostic simulation results for a uniform fine scale (left) and selectively upscaled (right) model with two normal faults.

FIG. 18 illustrates an example cut-cell grid for a field sector model.

FIG. 19 illustrates oil production rates for four producing wells in a field sector model simulation.

### DETAILED DESCRIPTION

Embodiments of the present invention relate to generation of an unstructured cut-cell grid that can be used to model the behavior of a subsurface reservoir. The unstructured cut-cell gridding embodiments disclose a truly 3D unstructured gridding approach that improves the accuracy and performance of upscaling and flow simulation, offers flexible resolution control, preserves truly 3D features of geologically consistent earth models, and improves the integration (usability and efficiency) of overall reservoir modeling workflows. The invention can be implemented in numerous ways, including, for example, as a method (including a computer-implemented method), a system (including a computer processing system), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore, are not to be considered limiting of its scope and breadth.

As will be described, embodiments of the present invention utilize a geochronological (GeoChron) map from physical coordinates to an unfaulted and unfolded depositional coordinate system. The mapping is represented implicitly on a tetrahedral mesh that conforms to geological discontinuities, and it facilitates accurate geostatistical modeling of static depositional properties. Geological discontinuities can be faults, fractures, or other changes in reservoir structure. For brevity, hereinafter, faults are often referred to, but one skilled in the art will recognize that other geological discontinuities can be treated similarly. An explicit representation of the geologic model is created as an unstructured polyhedral grid. Away from faults and other discontinuities, the cells are hexahedral, highly orthogonal, and arranged in a structured manner. Geometric cutting operations create general polyhedra adjacent to faults and explicit contact polygons across faults. Local grid coarsening and refinement are implemented that exploit the flexibility of unstructured grids to minimize upscaling errors and preserve critical geologic features. Because the simulation grid and the geologic model are constructed using the same mapping, fine cells can be nested exactly inside coarse cells. Therefore, flow-based upscaling can be applied efficiently without resampling onto temporary local grids. Algorithms and data structures for constructing, storing, and simulating cut-cell grids are described below. Examples illustrate accurate modeling of normal faults, y-faults, overturned layers, and complex stratigraphy. Flow results, including a field sector model, show the suitability of cut-cell grids for simulation.

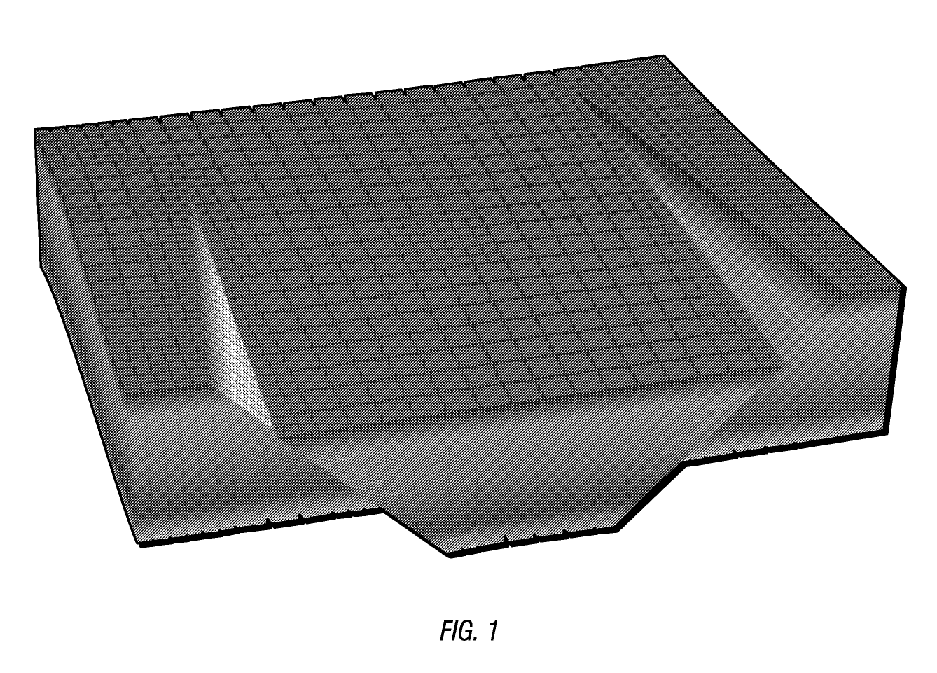

FIG. 1 shows an unstructured cut-cell grid for a model with two normal faults. Cell-based local grid refinement has been used to match the original earth model resolution around the faults and around vertical wells that are arranged in a five-spot pattern. As will be described, the cells are hexahedral and aligned with the {u,v,w} depositional coordinates away from the faults. Because the coordinate lines are not constrained to conform to the faults, orthogonality is maintained to a high degree. Geometric cutting operations are used to create general polyhedral cells adjacent to faults. Small cells formed by the cutting process have been removed through merging operations with their neighbors. The resulting polyhedral grid is water tight in the sense that each pair of neighboring grid cells, including neighbors across faults and neighbors with different refinement levels, shares an explicit polygonal interface. Cell-based local grid refinements can be included around faults and wells. Elements (e.g., grid vertices on the fault surfaces) are allowed to carry split properties so that multiple {u,v,w} values determined from the underlying tetrahedral mesh can be represented. Although the fault network is simple in this example, the discontinuity in the {u,v,w} transformation across faults is truly 3D. That is, there are discrete jumps in all three depositional coordinates at the split-property vertices along the faults.

As used herein, the term “property” (or “properties”) refers to values (typically, real numbers, integers, or Boolean flags, or arrays of these) that can be attached to an element (e.g., vertices, edges, polygons, polyhedra). Examples of properties include a node property representing depositional {u,v,w} coordinates, an edge property designating certain edges as tiplines of faults, a polygon property representing fluid transmissibility between adjacent polyhedra, and a polyhedron property representing porosity. Elements can also include split properties, which are properties that have multiple values at a single element. For example, elements on a geological discontinuity (e.g., a fault) can store depositional coordinates on both sides of the geological discontinuity as the depositional coordinates {u,v,w} often vary discontinuously at geological discontinuities. As will be described later herein, this is implemented by creating a list, where each element of the list consists of a vertex and polyhedron that is adjacent to the vertex. A single property value is attached to each element of this list. The split-property values at the given vertex are carried by the set of elements that contain the given vertex. Accordingly, properties such as depositional coordinates can be an ordinary property at some locations (e.g., vertices that are not on faults) and a split-property at other locations (e.g., vertices that are on faults).

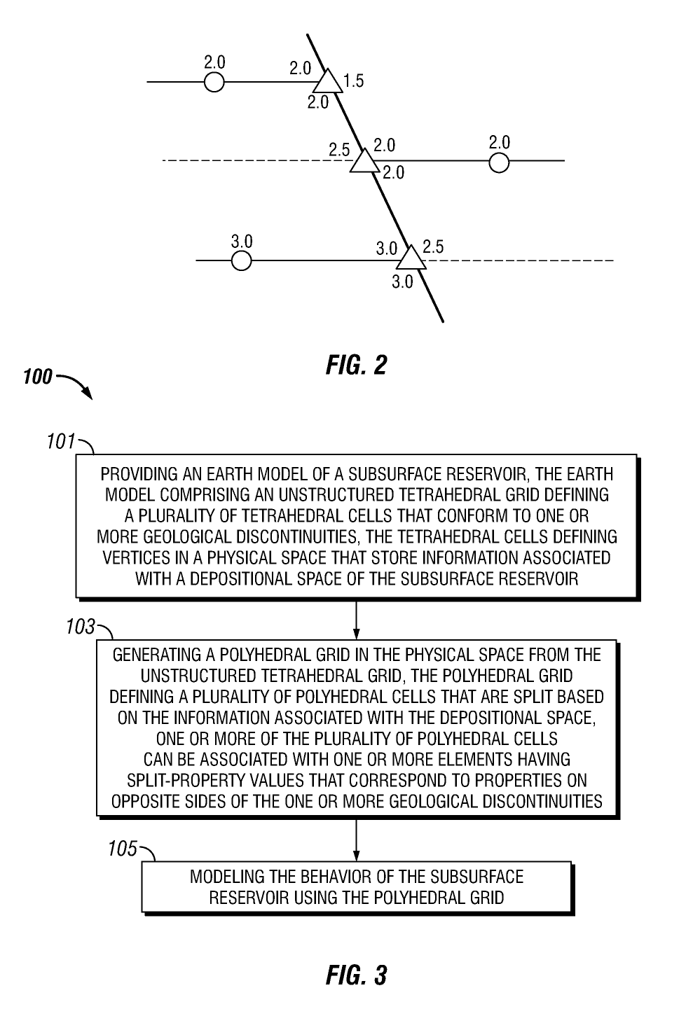

FIG. 2 is a schematic, in cross-sectional form, showing an example of ordinary properties and split properties at vertices. In this case, the property values represent depositional coordinate w. The round circles represent vertices with ordinary properties, and the triangles represent vertices with split properties. Because the depositional property w varies discontinuously across the fault (the thick diagonal line), the vertices on the fault carry multiple values of the property, which is keyed to the adjacent polyhedron. The dashed line in FIG. 2 represents an iso-value surface of 2.5 (i.e., w=2.5).

The construction of simulation grids, such as the unstructured cut-cell grid shown in FIG. 1, begins with a geologic model, which is a numerical representation of the reservoir structure, stratigraphy, and properties. Embodiments of the present invention utilize a GeoChron model for construction of the simulation grids. GeoChron offers several advantages over traditional methods for constructing geologically consistent numerical earth models within practical workflows. The main idea is to construct a transformation from the physical coordinates {x,y,z} to a depositional coordinate system {u,v,t} that is unfolded and unfaulted. The geologic time of deposition is represented by t(x,y,z), and {u(x,y,z), v(x,y,z)} are the paleo-geographic coordinates at the time of deposition. This transformation is independent of any corner-point grid, it facilities accurate geostatistical modeling of depositional properties, and it can accommodate complex fault networks and stratigraphy without excessive user intervention. Numerically, the coordinate transformation is represented implicitly by storing discrete {u,v,t} values at the vertices of a tetrahedral mesh that conforms to faults. The GeoChron framework provides an excellent starting point for constructing flow simulation grids and integrated workflows.

As described herein, the notation {u,v,w} for the depositional coordinates is used rather than notation {u,v,t} because depositional time does not carry special meaning for reservoir simulation. The piecewise continuous {u,v,w} coordinates can be viewed as a natural extension of the {i,j,k} indices of corner-point grids. Although the proposed grids are represented using generic polyhedral data structures, the {u,v,w} coordinates are stored explicitly in order to retain much of the visualization and interaction that users are accustomed to having with structured grids.

The transformation from physical {x,y,z} space to depositional {u,v,w} space can be stored on a tetrahedral mesh that conforms to faults and non-conforming surfaces. For brevity, hereinafter, only faults are referred to, but one skilled in the art will recognize that other non-conforming surfaces can be treated similarly. Tetrahedral meshes are a convenient data structure for this purpose due to their small memory footprint (even compared to a compressed polyhedral data structure), their geometric flexibility, and the availability of many algorithms for automatic generation. Discrete {u,v,w} values are stored at vertices of tetrahedra and can be interpolated linearly to any location within a tetrahedron. In order to represent the {u,v,w} discontinuity at faults, the tetrahedral mesh is separated at the faults by replicating vertices. This results in vertices that share the exact same {x,y,z} positions but store distinct {u,v,w} values. On the interior of tetrahedra, {u,v,w} values are unique. However, points on triangles that are associated with fault surfaces have two different {u,v,w} values that can be determined by linear interpolation within the two tetrahedra that originally shared the triangle. Similarly, points lying on edges of the tetrahedral mesh corresponding to intersections of faults can have three or more distinct values. Iso-value surfaces defined by constant values of u, v, and w are continuous everywhere except at faults.

For certain operations, it is convenient to consider the image of the tetrahedral mesh in the depositional space. Here, the vertices have {u,v,w} positions and store {x,y,z} values. Constant values of u, v, and w correspond to orthogonal planes. Due to erosions, some points in depositional space are not associated with any point in the physical space. This implies that there can be voids in the depositional space that are not filled by tetrahedra. Faults in {u,v,w} space are represented by two separate surfaces of triangles that will be closely aligned. But when viewed in this space, small gaps and overlaps may exist between the tetrahedra on opposite sides of a fault. Additional details on the GeoChron model can be found in Mallet (Space-time mathematical framework for sedimentary geology. Mathematical Geology, 36(1): 1-32, 2004), Moyen et al. (3d-parameterization of the 3d geological space—the GeoChron model. Proceedings of the 9th European Conference on the Mathematics of Oil Recovery, 2004), Mallet and Tertois (Solid earth modeling and geometric uncertainties. Presented at the 2010 SPE Annual Technical Conference and Exhibition, SPE 134978, 2010), and in U.S. Pat. Nos. 7,711,532B2 and 8,150,663B2, which are incorporated by reference in their entirety.

Embodiments of the present invention generate a polyhedral grid (i.e., cut-cell grid) utilizing the tetrahedral mesh defined by the GeoChron framework. In particular, a polyhedral grid is generated in the physical {x,y,z} space where polyhedral cells are partitioned or “cut” utilizing information in the depositional {u,v,w} space. For example, in one or more embodiments, polyhedral cells are cut along iso-value surfaces associated with the depositional space. In other embodiments, a Cartesian grid is constructed in the depositional {u,v,w} space and mapped into the physical {x,y,z} space, thereby intersecting the tetrahedral cells and producing the cut-cell polyhedral grid. In embodiments, a straightforward strategy can be used to define hexahedra for polyhedral cells that are away from faults and eroded regions. In the vicinity of such a cell, the grid topology is known. It is assumed that the tetrahedra that contact this cell do not overlap with any other tetrahedra, and each of the eight vertices can be associated uniquely with a tetrahedron. The positions of the vertices in physical space are therefore, determined uniquely by linear interpolation within these tetrahedra. As will be described, a more robust strategy is used to define cells in the vicinity of faults and eroded regions.

FIG. 3 illustrates a computer-implemented method 100 for generating a grid used for modeling the behavior of a subsurface reservoir. In step 101, an earth model of a subsurface reservoir is provided. The earth model comprises an unstructured tetrahedral mesh defining a plurality of tetrahedral cells that conform to one or more geological discontinuities. The tetrahedral cells define vertices in a physical coordinate system {x,y,z} that store information associated with a depositional space of the subsurface reservoir. For example, the vertices can store depositional properties such as the time of deposition and geographic locations at the time of deposition. In step 103, a polyhedral grid is generated in the physical space from the unstructured tetrahedral grid. The polyhedral grid defines a plurality of polyhedral cells that are split based on the information associated with the depositional space. One or more of the plurality of polyhedral cells can be associated with one or more elements (e.g., vertices, edges, contact polygons) having split-property values that correspond to properties on opposite sides of the one or more geological discontinuities. Elements that are adjacent to geological discontinuities can have multiple sets of properties (e.g., depositional properties) such that each set of properties correspond to properties on opposite sides of the geological discontinuities. The polyhedral grid is used to model the behavior of the subsurface reservoir in step 105. As previously discussed, modeling the behavior of the subsurface reservoir can include analyzing, forecasting, or simulating the behavior of fluid flow in hydrocarbon bearing subterranean reservoirs, such as gas or oil fields. Step 105 can therefore, be used for making reservoir management decisions, such as whether to develop new reservoir fields or how to efficiently manage production of current fields.

In embodiments, after the grid has been created, it can be refined by splitting a set of polyhedra at surfaces that are isovalues of a property. In many cases, this property will be one of the depositional properties (u, v, or w), but it can also be a property such as distance from a well, or distance from a plane that has a particular desired inclination. The set of polyhedra to be split can comprise the entire grid, or a limited set (e.g., polyhedra nearest a particular well). If at certain vertices the property is a split-property, then care must be taken when calculating the location of the isovalue surface to ensure that the property value is used that is appropriate to the polyhedron that is being split. When new nodes are created as a result of a split, correct property values (including split-property values if necessary) are also created. The halfedge data structure, which will be discussed later herein, allows the existing grid to be modified locally during the splitting operations (i.e., it is not necessary to create a new grid in order to implement the modifications).

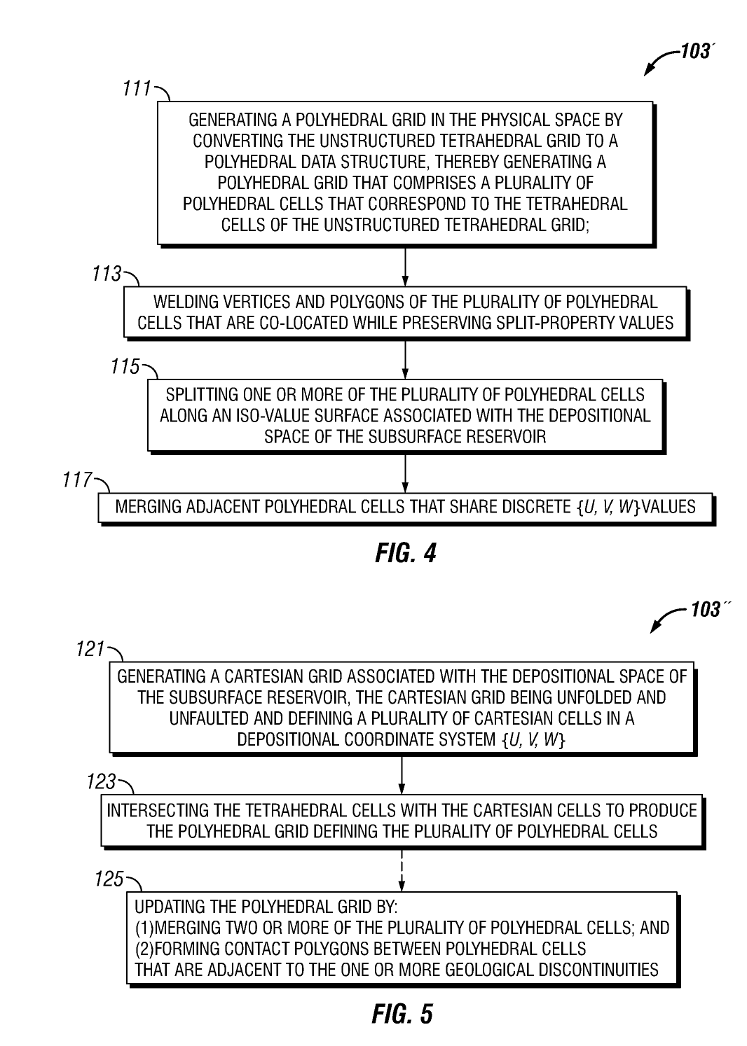

FIG. 4 illustrates an embodiment that can be used for generating the grid in step 103 according to computer-implemented method 100. In step 111, the polyhedral grid is generated by converting the unstructured tetrahedral grid to a polyhedral data structure. Here, the polyhedral grid comprises a plurality of polyhedral cells that correspond to the tetrahedral cells of the unstructured tetrahedral grid. For example, by converting each tetrahedron into a polyhedral cell, each polyhedron will have four polygonal faces, and each polygon will have three edges and three nodes. In step 113, the tetrahedral polyhedra are welded at geological discontinuities (e.g., faults) to arrive at a polyhedral grid that has no internal discontinuities topologically, but that has split-property values at vertices that lie on geological discontinuities. In particular, vertices and polygons that are co-located are welded while preserving split-property values. For example, in FIG. 2 the co-located vertices (shown as triangles) and associated co-located polygons (shown as lines between triangles) along the fault can be welded while preserving their split-property values. In step 115, one or more of the plurality of polyhedral cells are split along an iso-value surface associated with the depositional space of the subsurface reservoir. For example, the dashed line in FIG. 2 represents an iso-value surface of 2.5 (i.e., w=2.5). Therefore, this iso-value refinement splits cells of the grid along surfaces of common u, v, and w values. The u, v, and w values can be selected by the user to reflect a desired grid resolution. In step 117, adjacent polyhedral cells that share the same discrete {u,v,w} values are merged to form the polyhedral grid used to model the behavior of the subsurface reservoir. Merging in step 117 can occur after or substantially concurrently with the iso-value refinement.

In embodiments, in order to make this process (103′) more efficient, cells that are not adjacent to a geological discontinuity can be detected and constructed through a separate, more efficient process that takes into account the known topology of these cells. After the process is complete, cells in particular areas (e.g., near a geological discontinuity) can be refined using isovalue refinement, and small cells can be merged with their neighbors.

FIG. 5 illustrates another embodiment that can be used for generating the grid in step 103 according to computer-implemented method 100. In step 121, an unfolded and unfaulted Cartesian grid associated with the depositional space of the subsurface reservoir is generated. The Cartesian grid defines a plurality of Cartesian cells in a depositional coordinate system {u,v,w}. In step 123, a polyhedral mesh is generated on the physical coordinate system {x,y,z} by intersecting the tetrahedral cells with the Cartesian cells to produce a plurality of polyhedral cells. In embodiments, the polyhedral mesh is optionally updated in step 125. Two or more of the plurality of polyhedral cells are merged, and contact polygons are created between polyhedral cells that are adjacent to the one or more geological discontinuities. In some embodiments of step 125, the polyhedral grid is simplified by merging contact polygons shared by a common pair of adjacent polyhedra.

The embodiments shown in FIG. 5 therefore, build a Cartesian grid in the {u,v,w} space and map that grid into the physical {x,y,z} space. To begin, consider a partitioning of the depositional space into Cartesian cells without any local refinements. A straightforward strategy can be used to define the hexahedra for the cells that are away from faults and eroded regions. In the vicinity of such a cell, the grid topology is known. It is assumed that the tetrahedra that contact this cell do not overlap with any other tetrahedra, and each of the eight vertices can be associated uniquely with a tetrahedron. The positions of the vertices in physical space are therefore, determined uniquely by linear interpolation within these tetrahedra.

A more robust strategy is required to define cells in the vicinity of geological discontinuities (e.g., faults and eroded regions). First, each tetrahedron in the depositional space is considered and cut into polyhedral pieces based on the {u,v,w} grid partitioning. Each piece corresponds to the intersection of a tetrahedron with a Cartesian cell, and the intersection calculations are simplified by the fact that the Cartesian cell is aligned with the {u,v,w} coordinates. The cell pieces cannot be easily classified into a small number of predefined shapes. Therefore, they are temporarily stored as general polyhedra. Because each polyhedral piece is associated with a tetrahedron, the {x,y,z} positions of the vertices can be determined by interpolation. Although these polyhedral pieces can overlap with one another in depositional space, their images in the physical space do not overlap.

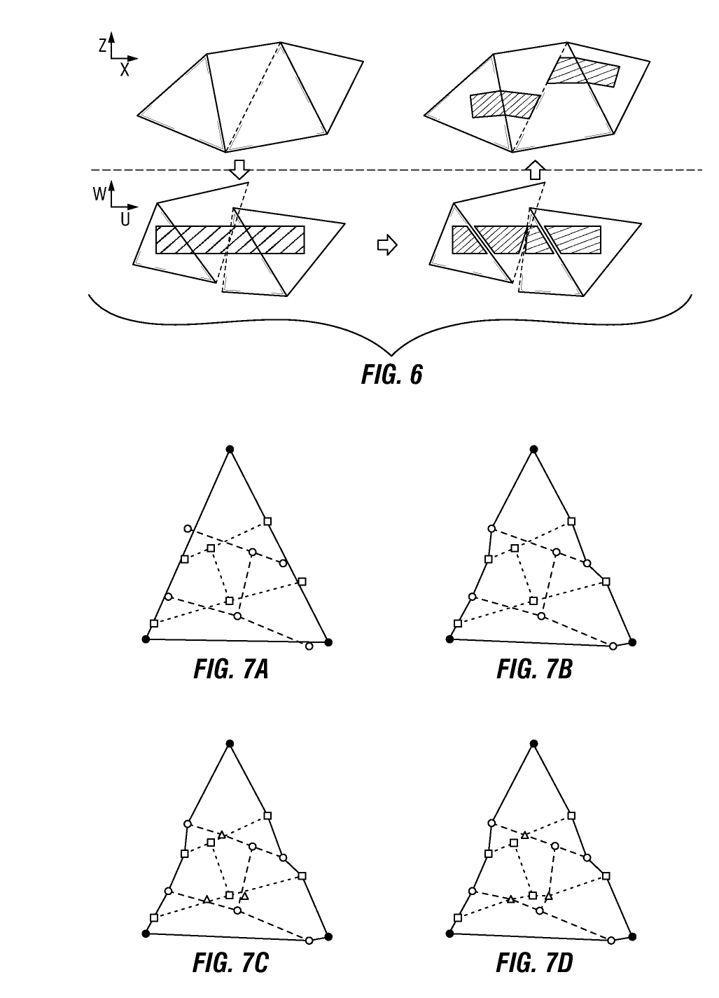

Cell pieces that are shared by adjacent tetrahedra and that originate from common Cartesian cells in the depositional space are collected. These collections are merged to form polyhedral cells that visually resemble the final cells in the grid. When traversing between adjacent tetrahedra to collect each piece, care is taken not to cross faults. Therefore, merging pieces that are separated by faults is avoided, and a single Cartesian cell can result in multiple polyhedra after merging. FIG. 6 is a 2D illustration depicting the transformation from physical space (top) to depositional space (bottom) that is used to generate cells that are cut by faults. Cartesian cells are created in depositional space, intersected with tetrahedra (here triangles), and the resulting polyhedral pieces are mapped back to physical space where they are merged to form grid cells.

There are several limitations of this intermediate polyhedral grid that are resolved before the grid is ready for simulation. First, the grid is lacking information concerning how cells contact one another across faults. The process of computing the contact polygons across faults is referred to herein as welding. Welding can be a very complex step in the gridding process due to the limitations of finite precision arithmetic. The second issue is that some of the cut polyhedral cells have small volumes that may present challenges for flow simulation. These cells can be removed by merging them with one of their neighbors. The criterion for identifying small cells can be based on the ratio of the cell volumes in {u,v,w} space to the volumes of their parent Cartesian cells. For the example shown in FIG. 1, a threshold of 0.35 was used. A final issue is that adjacent polyhedra in the intermediate grid share several common polygons. For the purposes of reservoir simulation, these multi-faceted interfaces between polyhedra are usually undesirable. Therefore, the interfaces are simplified by first merging polygons and then edges. Prior to simplifying the interfaces, the polygons in the grid are planar. Merged polygons will, however, in general not be planar. Interfaces corresponding to isosurfaces of constant u, v, and w can easily be simplified. For interfaces that correspond to faults, geometric criteria are used to decide when simplifications can be safely performed. The end result is that very few adjacent polyhedra in the final mesh share more than one polygonal interface.

In embodiments, the initial Cartesian grid in the depositional space need not be uniform. Based on well positions, fault locations, and any other criteria, modifications can be made to the base Cartesian grid. These modifications can include anisotropic refinement or coarsening of Cartesian cells. The resolution of the base grid can be chosen so that fine cells from the GeoChron earth model are nested exactly inside coarser simulation cells. Once this Cartesian grid has been built, the Cartesian cells that are contacted by triangles that represent faults in {u,v,w} space are flagged. This determines the polyhedral cells that can be formed by mapping vertices into physical space and the polyhedral cells that can be handled using the more involved procedure described above.

Welding Across Faults:

In embodiments, an algorithm for welding polyhedra across faults works in the physical space and uses a divide-and-conquer strategy based on triangles that correspond to fault surfaces. For each fault triangle, the polyhedra that contact the triangle on both sides are known. In addition, the polygons formed by the intersection of the triangles with the polyhedra are known. The task is to intersect these polygons across the fault and explicitly define smaller contact polygons that are shared by a fault triangle and a pair of polyhedra.

Ambiguities in the definition of polygons on both sides of the fault are removed before computing intersections triangle by triangle. Each triangle is projected onto its nearest coordinate plane (x, y, or z). Then, each triangle edge is projected onto its nearest coordinate line (x, y, or z). Each polygon vertex that belongs to a triangle edge is flagged if it projects to the same location as another vertex belonging to the same edge. Flagged vertices are then co-located so that they are treated identically in later stages of the algorithm. Using the perturbed polygons, the intersection problem can be solved on individual fault triangles and the results can be safely used to construct a topologically consistent polyhedral grid.

FIGS. 7A-7D illustrate steps in the welding process. In particular, FIG. 7A illustrates input line segments and triangle definition, FIG. 7B illustrates identification of edges along perimeter of the triangle, FIG. 7C illustrates new intersection points, and FIG. 7D illustrates final edges that define contact polygons. The positions of all points have been perturbed to emphasize the potential pitfalls of working with finite precision numbers.

The edges of each triangle are partitioned into segments that honor the polygons on both sides of the fault. Again, the best 1D coordinate projection (i.e., based on the orientation of polygons or edges being projected) is used for each edge. All polygon vertices associated with each triangle edge are gathered such that they can then be projected onto the coordinate line of the edge. Segments are formed based on the relative positions of vertices on this line, and these segments form a subset of the edges for the final contact polygons. See FIG. 7B.

The polygon edges that are interior to each triangle are projected onto the best coordinate plane of the triangle. The algorithm for resolving the intersections between the interior edges closely follows the approach of Hobby (Practical segment intersection with finite precision output. Computational Geometry, 14(4): 199-214, 1999). To determine if two edges intersect one another in 2D, the robust geometric predicates developed by Shewchuk (Adaptive precision floating-point arithmetic and fast robust geometric predicates. Discrete and Computational Geometry, 18:305-363, 1997) are used. Quad-double precision arithmetic (Algorithms for quad-double precision floating point arithmetic. Presented at the 15^{th} IEEE Symposium on Computer Arithmetic. IEEE Computer Society, 155-162, 2001) is used to compute intersection points, and the results are rounded to the closest double precision location. The challenge of resolving intersections stems from the fact that finite precision intersection points are rarely positioned on either of the two intersecting segments. Hence, the locations of the new segments formed by inserting the intersection point will, in general, be perturbed relative to the original two segments. This can lead to new intersections. Hobby's iterative strategy is able to resolve all possible intersections with a modest performance penalty relative to a straightforward search. The final segments only intersect one another at their end points as shown in FIG. 7D. The new intersection points are projected back into the true plane of each triangle to define grid vertex positions. To complete the welding process, the local topology of the grid is assembled by creating edges, identifying all contact polygons, and associating the polygons with their incident polyhedra.

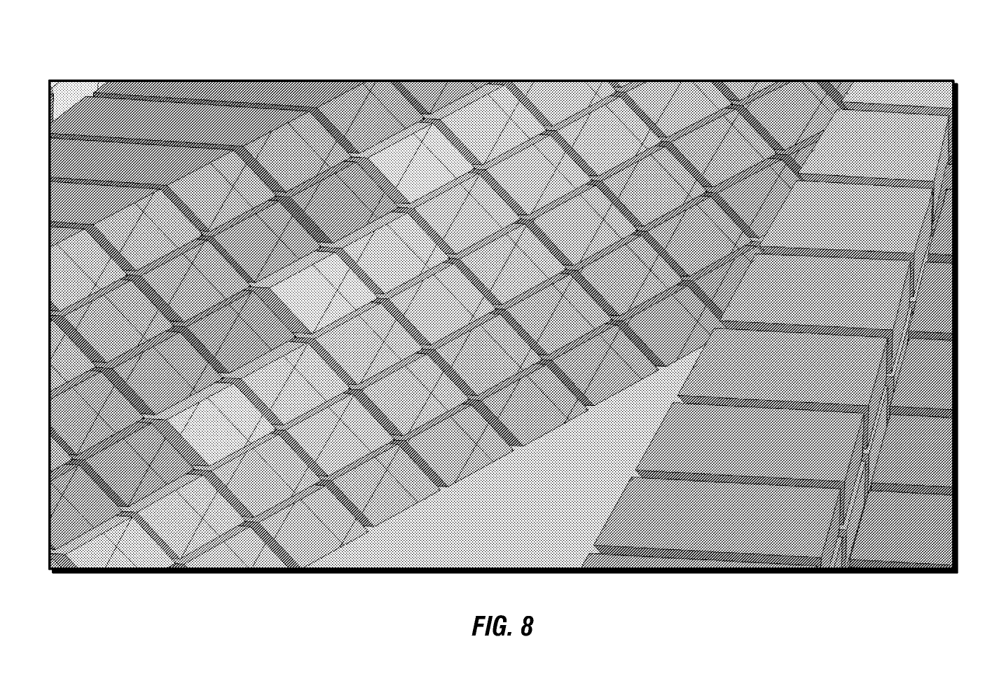

FIG. 8 shows an example of the contact polygons that are created by welding across a fault. Polyhedra on one side of the fault have been removed, and the remaining cells have been shrunken to reveal the contact polygons computed by the welding process. The welding process creates new vertices that lay on the fault, and welds together existing vertices across the fault that have common x, y, z locations. In the case of new vertices, properties and split properties need to be calculated. This property calculation could involve, for example, interpolation from nearby existing vertices. In the case of existing vertices, properties that are discontinuous at the fault need to be converted to split properties. Depending on the intended use of the grid, welding may not be necessary. For example, for some uses, it is sufficient to calculate the area of the contact polygons without explicitly calculating their vertices and adding them to the grid.

### Exceptional Polyhedra

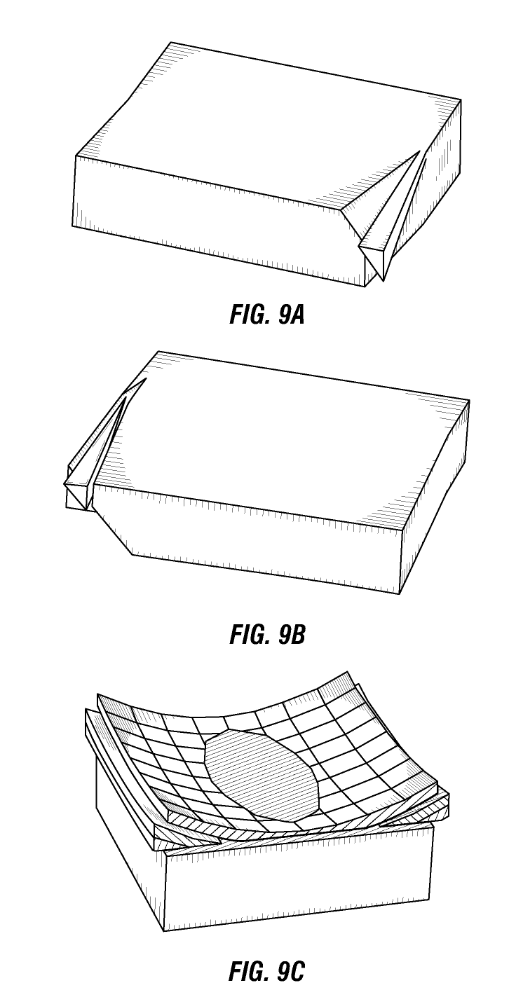

FIGS. 9A-9C illustrate examples of exceptional polyhedra. In particular, FIG. 9A illustrates a fault terminating within a polyhedral cell, FIG. 9B illustrates a sliver that was not successfully merged, and FIG. 9C illustrates a donut-shaped cell formed above a non-conforming surface.

Polyhedral grids created by the above procedure are topologically consistent and they closely honor the geometry of implicitly defined GeoChron earth models. They are well suited for flow simulation, but are not necessarily ideal. In some locations—such as where individual faults terminate—the resulting polyhedra can have very complex shapes. FIG. 9A shows an example of such a cell taken from the grid in FIG. 1. This polyhedron, for example, shares two polygons with the cells directly above. One of the polygons corresponds to a surface of constant w, and the other corresponds to a fault surface. In some embodiments, faults can be extended to remove this configuration. In some embodiments, these cells are allowed to persist and two-point flux approximations are exclusively applied for these polygons. For the polygons associated with the fault surfaces, a standard flux approximation may yield a negative transmissibility (indicating that the cell center is on the wrong side of the polygonal interface). The transmissibility can be set to zero in these cases.

In rare cases such as the one shown in FIG. 9B, the procedure for merging small cells with adjacent polyhedra fails. Merging appears to fail only when the flagged polyhedra are much smaller than the threshold volume tolerance, and their occurrence is limited to locations where faults terminate. To avoid any possible complications, these cells can be inactivated in simulation models.

A final exceptional case is shown in FIG. 9C. This type of donut-shaped polyhedral cell can exist within thin stratigraphic layers that are pinched out from above or below by a non-conforming surface. Accommodating this configuration with the data structure requires special consideration. But, by including one or more extra edges in the description of the topology, both polygons containing holes and polyhedra that contain voids can be represented. Using these cells in flow simulations, however, remains problematic. These polyhedra can be removed through merging operations, or they can be inactivated.

### Polyhedral Data Structure

Each of the above described methods (e.g., computer-implemented method 100) utilize a polyhedral data structure, which offers tremendous flexibility in representing 3D simulation grids. But in order to realize these benefits, the data structure must be efficient enough in terms of memory consumption and execution time to meet user expectations for interactive workflows. The fundamental ideas behind polyhedral grid representations and a compression strategy that enables work with high resolution grids are described below.

Terminology used herein to describe 3D polyhedral grids is provided below:
An element of dimension N defines a closed domain in [symbol] ^{N}. Element types are vertices, edges, polygons and polyhedra.
An element e₁ is incident to another element e₂ if they share a common element e_{c}, which could be equal to e₁ or e₂. Incident elements can have different dimensions.
An element of dimension iε[1,N] is adjacent to another element of dimension i if they share a common element of dimension (i−1).
The terms mesh and grid are used interchangeably. A 3D grid is a set of elements whose highest dimension is three. The grid typically provides access to the topological relationships between elements, and it includes the geometrical information regarding the spatial positions of the vertices.
A topological query or simply a query on a 3D grid is the search for all elements of dimension i incident to a given element of dimension j, with {i,j}ε[0,3] and i≠j. Generally, it is desired that the algorithmic complexity of all topological queries be constant or bounded.
A grid is complete if it permits all possible topological queries.
A halfedge in 3D is not an element, but it can be viewed as an oriented edge. A halfedge is uniquely associated with a quadruplet of elements {e⁰, e¹, e², e³} where each element e^{d} is an element of dimension dε[0,N].
A property is a value that can be attached to an element (e.g., e⁰, e¹, e², e³).
A split-property is a property that has multiple values at a single element. The values are keyed to a parent element that is incident to the child element. Typically, the property values are associated with a vertex and are keyed to the polyhedra that are incident to that vertex, which allows the representation of depositional properties that are discontinuous across a fault.

Halfedge Data Structure:

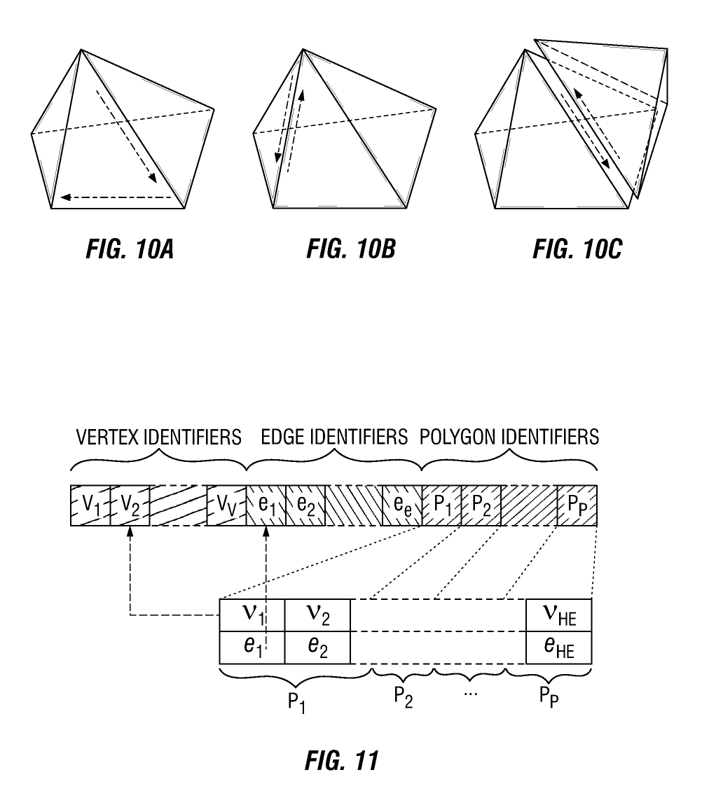

Each of the four elements associated with a halfedge are said to be incident to the halfedge. Similarly, the definition of adjacency is extended to allow a halfedge to have three adjacent halfedges across its incident elements eⁱ, iε[0,2]. The three adjacency relationships are depicted in FIGS. 10A-10C, and they provide the basis for queries on a halfedge data structure. In particular, FIG. 10A illustrates the adjacency of dimension 0, FIG. 10B illustrates the adjacency of dimension 1, and FIG. 10C illustrates the adjacency of dimension 2. The adjacent halfedge shown in FIG. 10A of dimension 0 is referred to as the next-halfedge-around-polygon, the adjacency shown in FIG. 10B of dimension 1 is referred to as the polygon mate, and the adjacency shown in FIG. 10C of dimension 2 is referred to as the polyhedron mate.

A straightforward implementation of a 3D halfedge data structure typically relies on pointers to access the triplet of adjacent halfedges and the quadruplet of incident elements for each halfedge. Hence, seven pointers are used for every halfedge in the grid. In addition, each element stores a pointer to one of its halfedges. This allows the reconstruction of the element's complete list of associated halfedges using the adjacency relationships described above. The vertices also store their {x,y,z} positions. To make the data structure complete, the grid itself stores a pointer to a single halfedge, assuming that all elements form one connected component. But, it is more common to store lists of elements (or lists of pointers to elements) for direct access, since the efficiency of queries involving all elements in the grid is improved.

The storage required for halfedges is substantial due to the seven associated pointers and the fact that the number of halfedges is significantly larger than any of the element types. For example, a single hexahedron has 24 associated halfedges. A compression strategy to address the storage of halfedges in memory is described below.

Compressed Halfedge Data Structure:

The concept of implicit data access is utilized to limit the memory requirements of the halfedge data structure. As in the uncompressed legacy implementation, the compressed implementation relies on arrays of elements and halfedges. It retains the flexibility of the format described above; polyhedra are not restricted to predefined types and can be inserted, deleted, subdivided, merged, or morphed into another type of polyhedron at run time. A distinction is made between a halfedge and the concept of a minimal halfedge, which represents the minimal amount of data that must be stored to reconstruct the information associated with a halfedge at an acceptable cost. This allows for a reduction in memory consumption of a halfedge from seven pointers—i.e., 56 bytes on a 64-bit machine—to only 2 bytes. In this compressed form, the minimal halfedge can no longer support all topological queries. The role of the polyhedron is increased to restore completeness to grids. This approach assumes that all vertices, edges and polygons are associated with at least one polyhedron, which makes the grids a specialization for 3D.

The implementation replaces element pointers with global element identifiers whenever possible to save memory. A pointer uses 8 bytes on a 64-bit machine, whereas global element identifiers can be encoded as 4-byte integers. Here, elements are stored in global lists attached to the grid structure. This also results in contiguous storage for elements, which improves overall cache performance.

To enforce completeness, polyhedra store lists of incident polygons, edges, vertices as well as their associated minimal halfedges. The incident elements are stored locally within each polyhedron, using a single list of global element identifiers. FIG. 11 illustrates a schematic of a compressed data structure for a single polyhedron. The elements list stores all global identifiers for the vertices, edges and polygons incident to the polyhedron, and the minimal halfedge list contains local vertex and edge identifiers that point to the elements list. Entries in the minimal halfedge list are grouped by polygon and ordered to avoid explicit storage of the next-halfedge-around-polygon.

Each polyhedron knows its number of associated vertices, edges, and polygons so that it can infer the type of each identifier. In addition, each polyhedron carries a pointer to its grid data structure so that it can directly access the global element lists. Each polygon stores a pointer to one of its incident polyhedra and the index of its other incident polyhedron. A negative index denotes a boundary polygon. The representation of edges and vertices remains largely unchanged, with the notable exception that the pointer to a halfedge is replaced by a pointer to one of the incident polyhedra.

The minimal halfedges are ordered in a local list so that all minimal halfedges associated with a polygon are grouped together, and all but the last entry for each polygon appears directly before its next-around-polygon mate. The groups are ordered in the same sequence as the polygons (FIG. 11). Each minimal halfedge stores the local index of its vertex in its polyhedron's local vertex list. Similarly, it stores the local index of its edge in its polyhedron's local edge list. To distinguish between the halfedge groups, the first minimal halfedge of each polygon is tagged using a negative local vertex index. Each of these local indices is encoded as a 1-byte integer, which limits the number of vertices to 127 and the number of edges to 256. The number of bytes used to encode the local indices can be customized at run time to release this constraint at the expense of a larger memory footprint.

The completeness of the compressed implementation can be confirmed by showing that each (minimal) halfedge can access its quadruplet of incident elements and its triplet of adjacent halfedges. Accessing the incident polyhedron, edge and vertex is straightforward and four cases are described below:
Polygon access: Assume that the j-th halfedge in a polyhedron is incident to the k-th polygon in a polyhedron. The value of k can be determined by counting the number of negative local vertex indices appearing in the first j entries of the minimal halfedge list. Once k is known, the global element identifier for this polygon can be retrieved and used to access the element.
Next-halfedge-around-polygon access: The next-halfedge-around-polygon corresponds to the next entry in the minimal halfedge list, if that local vertex index is positive. If it is negative or if the end of the list is reached, then one can backtrack to the first minimal halfedge of the polygon.
Polygon mate access: The polygon mate of the j-th halfedge is taken as the first entry in local minimal halfedge list that shares the same edge. The list is traversed in the forward direction beginning at the (j+1)-th position. If no valid entry is found, the search is restarted from the beginning of the list.
Polyhedron mate access: The polyhedron mate of a halfedge is accessed through three steps: (1) access the polygon for the halfedge, (2) access the opposite polyhedron for this polygon, and (3) traverse the minimal halfedge list of that polyhedron until an entry is found that matches both the polygon and the edge of the given halfedge.

Results for Memory Footprint and Topological Queries:

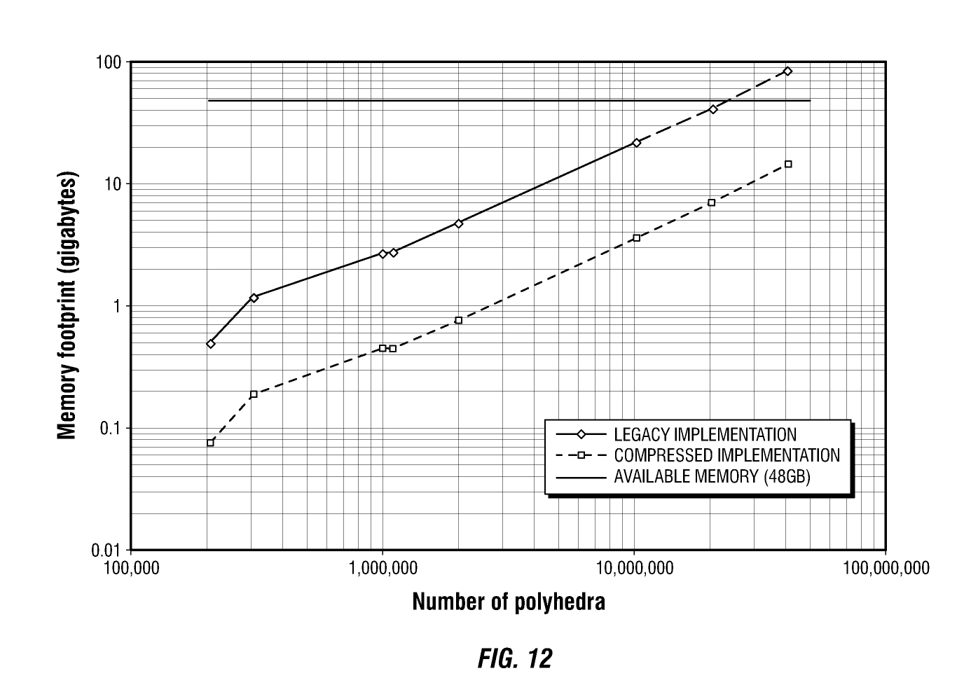

In the compressed polyhedral grids, the memory footprint can easily be determined for vertices, edges, and polygons. The footprints of polyhedra vary based on the sizes of their local lists. Footprints between 150 and 230 bytes per polyhedron are typically observed. FIG. 12 shows a comparison of compression information and the memory footprints for several example grids with up to 40 million polyhedra. Observations and predictions based on counts of incident elements for polyhedra yield compression rates between 78% and 85% relative to the legacy halfedge data structure on 64-bit machines. For example, for the compressed implementation, the two grids with around 1 million polyhedra consume just over 0.5 Gb each, and the largest grid with 40 million polyhedra has a footprint of 14.6 Gb.

Compression alone is not sufficient for practical management of polyhedral grids—the speed of topological queries is also critical. The table below shows the relative speed of various topological queries on the compressed and legacy data structures. Factors less than unity signify slower execution time with compression. Due to the polyhedron-centric design, all queries on polyhedra are significantly faster with the compressed implementation. Querying a polygon's polyhedra is also faster because polygons explicitly store this information. All other queries are less efficient with compression due to the increased cost of accessing halfedge polygon mates and polyhedron mates.

| | . . . poly- | . . . poly- | | . . . ver- |
|---|---|---|---|---|
| | hedra | gons | . . . edges | tices |
| Query a polyhedron's . . . | — | 42.0 | 28.0 | 32.3 |
| Query a polygon's . . . | 2.7 | — | 0.5 | 0.5 |
| Query an edge's . . . | 0.2 | 0.2 | — | 0.4 |
| Query a vertex's . . . | 0.3 | 0.3 | 0.5 | — |

The above described methods can be implemented in the general context of instructions executed by a computer. Such computer-executable instructions may include programs, routines, objects, components, data structures, and computer software technologies that can be used to perform particular tasks and process abstract data types. Software implementations of the above described methods may be coded in different languages for application in a variety of computing platforms and environments. It will be appreciated that the scope and underlying principles of the above described methods are not limited to any particular computer software technology.

Moreover, those skilled in the art will appreciate that the above described methods may be practiced using any one or a combination of computer processing system configurations, including, but not limited to, single and multi-processor systems, hand-held devices, programmable consumer electronics, mini-computers, or mainframe computers. The above described methods may also be practiced in distributed or parallel computing environments where tasks are performed by servers or other processing devices that are linked through one or more data communications networks. For example, the large computational problems arising in reservoir simulation can be broken down into smaller ones such that they can be solved concurrently—or in parallel. In particular, the system can include a cluster of several stand-alone computers. Each stand-alone computer can comprise a single core or multiple core microprocessors that are networked through a hub and switch to a controller computer and network server. An optimal number of individual processors can then be selected for a given problem based on factors such as reservoir partitioning where the reservoir grid cells are divided into domains that are assigned to the individual processors.

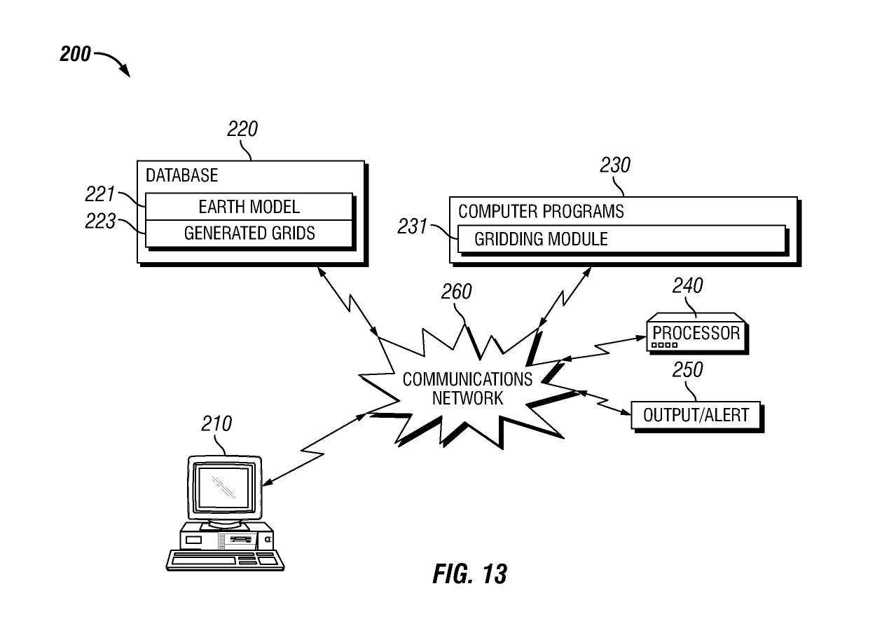

FIG. 13 illustrates a system 200 for generating a grid used for modeling the behavior of a subsurface reservoir, such as by implementing computer-implemented method 100. System 200 includes user interface 210, such that an operator can actively input information and review operations of system 200. User interface 210 can be any means in which a person is capable of interacting with system 200 such as a keyboard, mouse, or touch-screen display. Operator-entered data input into system 200 through user interface 210 can be stored in database 220. Additionally, any information generated by system 200 can be stored in database 220. Earth models 221 of subsurface reservoirs with tetrahedral meshes and computer generated unstructured or structured grids 223 (e.g., Cartesian, polyhedral) are examples of information that can be stored in database 220.

System 200 includes software instructions or computer program 230 that is stored on a non-transitory computer usable or processor readable medium. Current examples of such non-transitory medium include, but are not limited to, read-only memory (ROM) devices, random access memory (RAM) devices, and semiconductor-based memory devices. This includes flash memory devices, programmable ROM (PROM) devices, erasable programmable ROM (EPROM) devices, electrically erasable programmable ROM (EEPROM) devices, dynamic RAM (DRAM) devices, static RAM (SRAM) devices, magnetic storage devices (e.g., floppy disks, hard disks), optical disks (e.g., compact disks (CD-ROMs)), and integrated circuits. Non-transitory medium can be transportable such that the one or more computer programs (i.e., a plurality of software instructions) stored thereon can be loaded onto a computer resource such that when executed on the one or more computers or processors, performs the aforementioned functions of the various embodiments of the present invention.

System 200 includes one or more modules and/or is in communication with one or more devices (e.g., a linear solver) configured to perform any step of any of the methods (e.g., method 100) described herein. Processor 240 interprets instructions to execute software 230 and generates automatic instructions to execute software for system 200 responsive to predetermined conditions. Instructions from both user interface 210 and software 230 are processed by processor 240 for operation of system 200. In some embodiments, a plurality of processors can be utilized such that system operations can be executed more rapidly.

An example of a module for software 230 includes, but is not limited to, gridding module 231. Gridding module 231 can have computer-readable software instructions to obtain information from database 220. For example, gridding module 231 can retrieve stored earth models of subsurface reservoirs. The earth models can have an unstructured tetrahedral mesh defining a plurality of tetrahedral cells that conform to one or more geological discontinuities. The tetrahedral cells define vertices in a physical coordinate system {x,y,z} that store information associated with a depositional space of the subsurface reservoir. Gridding module 231 has computer-readable software instructions to generate a polyhedral grid in the physical space from the unstructured tetrahedral grid. The polyhedral grid defines a plurality of polyhedral cells that are split based on the information associated with the depositional space. One or more of the plurality of polyhedral cells can be associated with one or more elements (e.g., vertices, edges, contact polygons) having split-property values that correspond to properties (e.g., depositional properties) on opposite sides of the one or more geological discontinuities. The polyhedral grid is used to model the behavior of the subsurface reservoir. As previously discussed, modeling the behavior of the subsurface reservoir can include analyzing, forecasting, or simulating the behavior of fluid flow in hydrocarbon bearing subterranean reservoirs, such as gas or oil fields. Therefore, system 200 can be used for making reservoir management decisions, such as whether to develop new reservoir fields or how to efficiently manage production of current fields.

In certain embodiments, system 200 can include reporting unit 250 to provide information, such as a display of generated grids, to the operator or to other systems (not shown). For example, reporting unit 250 can be a printer, display screen, or a data storage device. However, it should be understood that system 200 need not include reporting unit 250, and alternatively user interface 210 can be utilized for reporting information of system 200 to the operator.

Communication between any components of system 200, such as user interface 210, database 220, software 230, processor 240 and reporting unit 250, can be transferred over a communications network 260. Computer system 200 can be linked or connected to other, remote computer systems (e.g., a forward simulation module) via communications network 260. Communications network 260 can be any means that allows for information transfer to facilitate sharing of knowledge and resources, and can utilize any communications protocol such as the Transmission Control Protocol/Internet Protocol (TCP/IP). Examples of communications network 260 include, but are not limited to, personal area networks (PANs), local area networks (LANs), wide area networks (WANs), campus area networks (CANs), and virtual private networks (VPNs). Communications network 260 can also include any hardware technology or equipment used to connect individual devices in the network, such as by wired technologies (e.g., twisted pair cables, co-axial cables, optical cables) or wireless technologies (e.g., radio waves).

In operation, an operator initiates software 230, through user interface 210, to perform the methods described herein (e.g., FIGS. 3-5). Outputs from each software module can be stored in database 220. A visual display can be produced, such as through reporting unit 250 or user interface 210, using the outputs of software 230. For example, the earth model and corresponding generated polyhedral grid can be transformed into image data representations for display to a user or operator. Alternatively, outputs from software 230 can be sent to other systems (not shown). The output information can be utilized to forecast or optimize the production performance of the subterranean reservoir, which can then be used for reservoir management decisions. For example, output from system 200 can be used to determine cumulative fluid injection amounts, fluid injection rates, cumulative fluid production amounts, fluid production rates, bottom hole pressure (BHP) profiles for injectors and producers, and the net present value (NPV) of an optimized case.

### Numerical Examples

This section presents additional cut-cell grid generation examples and flow simulation results for the grid shown in FIG. 1. Results from a field simulation study are also presented using a cut-cell grid for a sector with six faults.

Gridding a y-Fault:

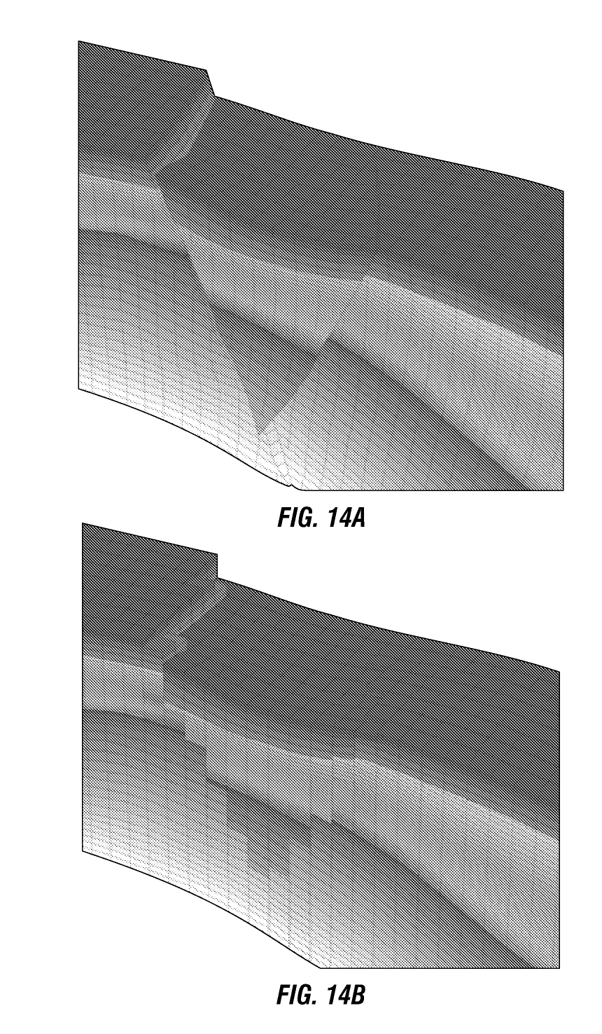

The GeoChron framework allows for y-fault geometry to be modeled accurately, and it enables geologically consistent computation of distances in depositional space in the vicinity of y-faults. FIGS. 14A and 14B compare a cut-cell grid (14A) and a vertically stair-stepped grid (14B) that were created from a GeoChron model containing a y-fault. The stair-stepped grid was generated using the approach of Gringarten et al. (New grids for robust reservoir modeling. Presented at the 2008 SPE Annual Technical Conference and Exhibition, SPE 116649, 2008) and Gringarten et al. (Advantages of using vertical stair step faults in reservoir grids for flow simulation. Presented at the 2009 SPE Reservoir Simulation Symposium, SPE 119188, 2009), and it contains columns of cells that are exactly vertical. Both grids accurately capture the stratigraphy of the GeoChron model, but only the cut-cell grid preserves the geometry of the faults.

Overturned Stratigraphy:

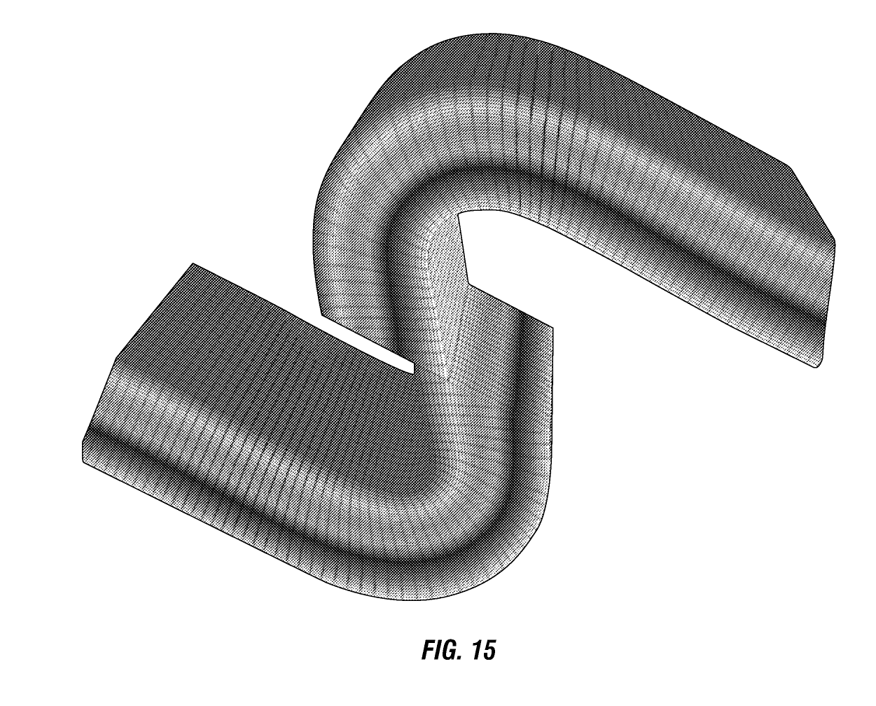

Some pillar-based approaches to constructing corner point grids have difficulty representing steeply sloping or completely overturned stratigraphy. The example in FIG. 15 illustrates that cut-cell grids can accommodate either case in the presence of a fault. In the regions of the grid where the {u,v,w} transformation has stretched the cells, local refinements that help maintain more uniform cell sizes in the physical space are added.

Complex Stratigraphy:

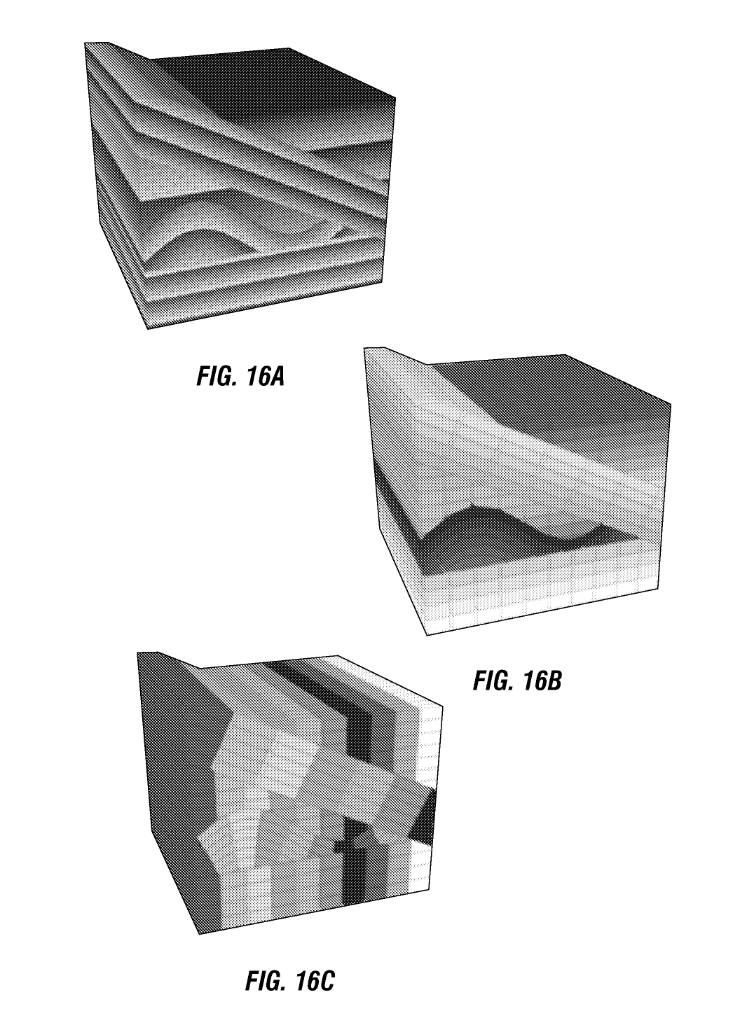

While preservation of complex fault networks has been a primary motivation behind the design of cut-cell grids, the flexibility of the grid generation process has utility in cases without faults. FIGS. 16A-16C illustrate an example for a synthetic model with complex stratigraphy (i.e., containing several non-conformities) represented implicitly on a tetrahedral mesh. FIG. 16A illustrates a tetrahedral mesh with interpolation of the w coordinate, FIG. 16B illustrates the cut-cell grid shaded by average w value for polyhedra, and FIG. 16C illustrates a cut-cell grid shaded by average u value for polyhedra. FIGS. 16B and 16C show the resulting cut cell grid that honors the stratigraphic layering everywhere while also preserving four non-conforming surfaces. Cell merging was not used to remove small cells in this example.

Flow Diagnostics with Normal Faults:

For the first flow simulation example, a flow diagnostic simulation (An alternative to streamlines for flow diagnostics on structured and unstructured grids. Soc. Pet. Eng. J., 17(3): 768-778, 2012) based on the synthetic model shown in FIG. 1 is considered. These fast and simple flow calculations are based on a model for incompressible, single-phase flow and tracer transport. A two-point flux approximation is used for the flow calculation. Rather than dynamically evolving tracers with a time stepped procedure, a locally conservative, first order discretization of the time-of-flight equation and a fast sweeping solver to predict the arrival time of tracers in grid cells and at the four producing wells is used (An efficient discontinuous Galerkin method for advective transport in porous media, water injection optimization using a streamline-based workflow, Advances in Water Resources, 30: 2424-2438, 2007; and Fast computation of multiphase flow in porous media by implicit discontinuous Galerkin schemes with optimal ordering of elements, J. Comput. Phys., 227(24): 10108-10124, 2008). The diagnostic simulations use a dimensionless BHP of unity for injectors and zero for producers.

Two different cut-cell grids were constructed from a GeoChron model that was parameterized using a geocellular {u,v,w} grid with dimensions 42×36×51. The average size of the cells in physical space is 50×50×10 meters. The permeability and porosity fields were taken from the 10^{th} SPE Comparative Solution Project (Tenth SPE comparative solution project: A comparison of upscaling techniques. Soc. Pet. Eng. Res. Eval. and Eng., 4(4):308-317, 2001) and modified for the purpose of this example. Specifically, the first 42 rows in the x-direction, the first 36 rows in the y-direction, and the top 35 layers from the data set, which correspond to the Tarbert formation, were extracted. To populate the bottom 16 layers of the model, the properties from layers 20 through 35 were mirrored. Vertical wells were placed in a five-spot pattern. The first grid was built at the same resolution as the GeoChron model. The second grid was coarsened by a factor of two in the u and v coordinate directions and then refined back to the original resolution around the faults and wells. Diagonal permeability tensors were determined for the coarser cells using a flow-based method. Fault juxtaposition and cell merging operations were not taken into account during upscaling.

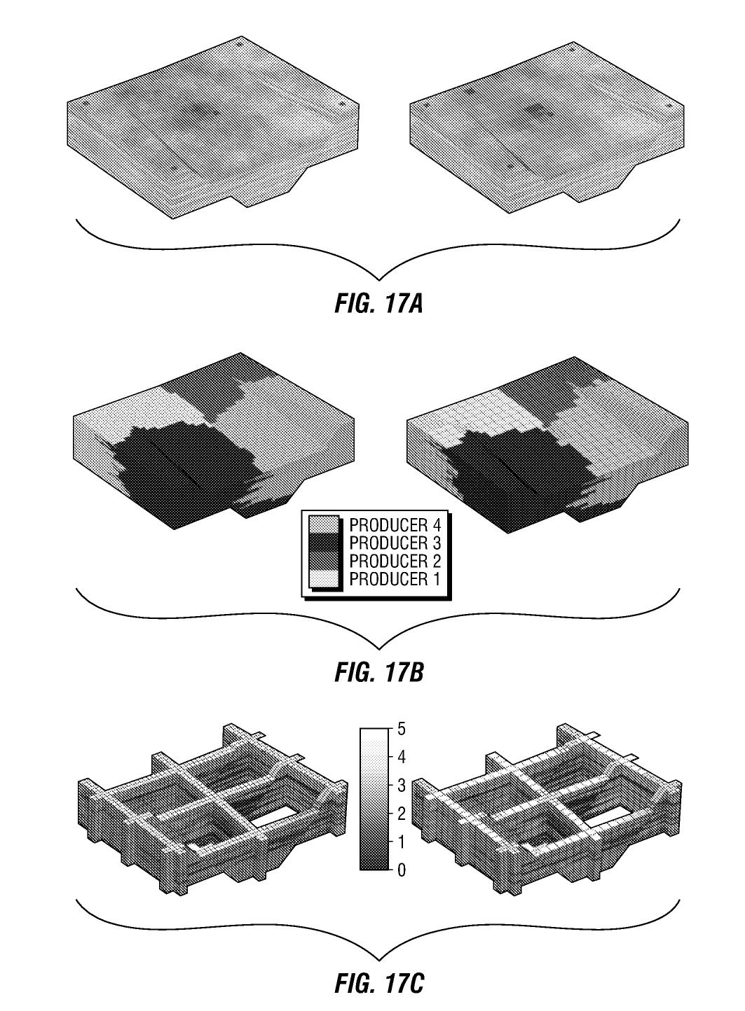

FIGS. 17A-17C illustrate flow diagnostic simulation results for a uniform fine scale (left) and selectively upscaled (right) model with two normal faults. FIG. 17A illustrates log permeability in the u coordinate direction with vertical well positions indicated by dark shaded cells in the five-spot pattern. FIG. 17B shows the computed drainage regions for each of the four producers. The shading in FIG. 17B indicates the producer that is most strongly associated with each polyhedral cell as determined by tracers that flow backwards in time from each producer. The volumes of the drainage regions and the flux allocation with respect to the field wide results for the fine case are given in table below. The most notable discrepancy between the two grids is that the total flow rate differs by 3.7%. FIG. 17C shows the computed total travel time for each grid cell in units of pore volumes injected (PVI). Total travel time along with the total pore volume of each cell is used to compute flow capacity-storage capacity diagrams and the dynamic Lorenz coefficients given in the table below. The shading in FIG. 17C is clipped at an upper bound of 5 PVI. The close correspondence of Lorenz coefficients between the two grids suggests that the coarser grid adequately captures the heterogeneity of the finer grid.

| | Pore | | | | Lorenz | |
|---|---|---|---|---|---|---|
| | Volume % | | Flux % | | (dynamic) | |
| Flow Region | Fine | Upsc | Fine | Upsc | Fine | Upsc |
| Field Wide | — | 100.0 | — | 96.3 | 0.48 | 0.47 |
| Producer 1 | 20.7 | 20.6 | 20.0 | 19.4 | 0.51 | 0.50 |
| Producer 2 | 24.7 | 24.7 | 25.9 | 24.8 | 0.43 | 0.42 |
| Producer 3 | 25.0 | 24.9 | 16.6 | 16.1 | 0.45 | 0.44 |
| Producer 4 | 29.6 | 29.7 | 37.5 | 36.0 | 0.48 | 0.47 |

Field Sector Model Simulation:

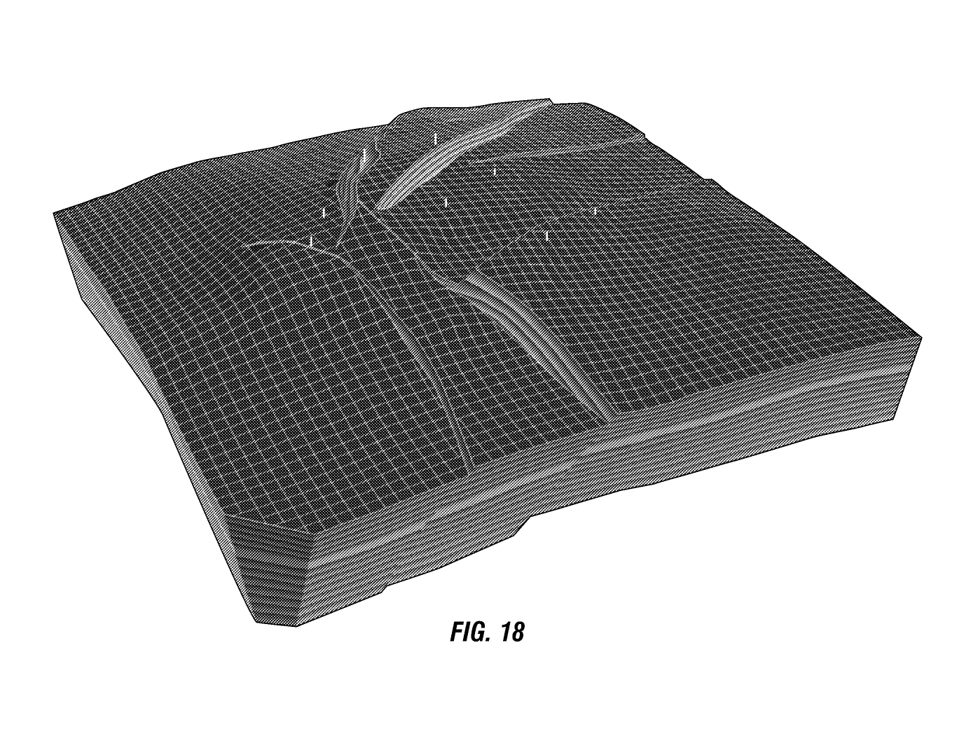

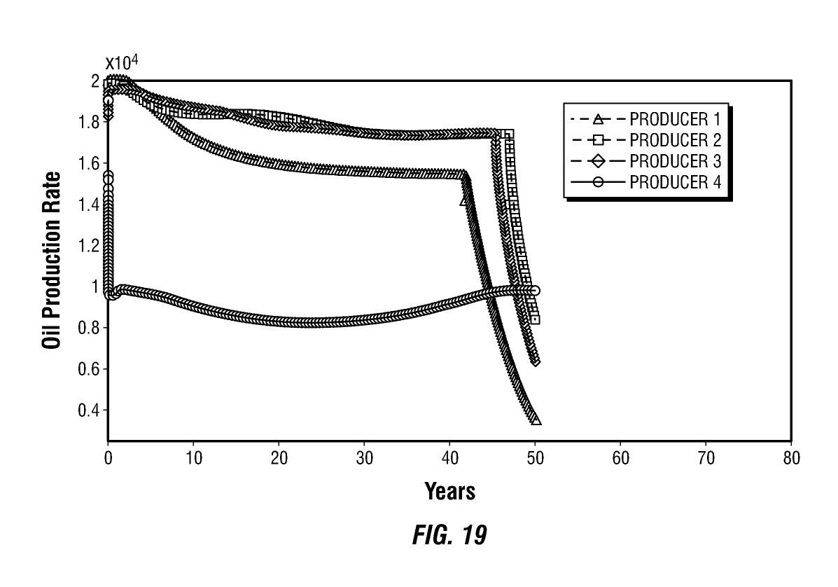

FIG. 18 shows an example cut-cell grid for a field sector model with six faults with shading corresponding to the average w coordinate of each polyhedron. The white line segments protruding from the top horizon represent the wells used in the simulation. This grid was constructed at the same resolution as the GeoChron earth model which contained 50×50 cells areally and 1000 layers. The simulation model contains 1,054,605 active cells and 3,064,383 connections. The model was imported into the Intersect reservoir simulator (available from Schlumberger Limited, headquartered in Houston, Tex.) and run for a period of 50 years. Fluid and petrophysical property data were taken from a light oil (API ˜28) in a sandstone reservoir. The model has a total pore volume of 1.7e9 RB and 5.6e9 STB of initial oil in place. There are 8 wells in the model, 4 water injectors and 4 producers. The injectors were constrained on both injection pressure and water injection rate; the producers were constrained on bottom hole pressure, draw down, and total fluid rate. The model ran successfully on 8 CPUs in about 9 hours without significant convergence issues. Well performance, as indicated in FIG. 19, shows the expected high initial rates followed by gradual declines as pressure in the model declined, and steeper declines after pressure constraints were reached.

The overall approach to unstructured gridding retains many of the strengths of structured corner-point grids. Hexahedral cells are utilized wherever possible and resolution is controlled using cell-based local grid refinement and coarsening. The structured aspects of cut-cell grids allow one to leverage existing algorithms for visualization, discretization, and simulation that are proven to be effective. In particular, the ability to maintain a structured relationship between the coarse simulation grid and the fine underlying geologic grid aids in the efficiency and accuracy of flow-based upscaling. By utilizing a generic polyhedral data structure, flexibility is gained in representing realistic structure and stratigraphy. Cutting and merging operations in the vicinity of faults can lead to very general cell geometries. However, these more complex polyhedra are not treated as special cases within this framework. All polyhedral cells are stored and manipulated in the same way regardless of their number of incident polygons or whether they are adjacent to faults. This generic design has helped to simplify many of the algorithms involved in preparing grids for reservoir simulation. Moreover, the ability to store complete grid information has allowed for clean separation of grid generation and alteration from functionality associated with flow simulation.

Challenges associated with simulating cut-cell grids are concentrated in the regions around faults and non-conforming surfaces. Both cutting and merging operations can lead to nonorthogonality. For the simulation examples presented here, two-point flux approximations (TPFA) are used. Local error analysis and numerical tests reveal the inconsistency of TPFA for grids that are not K-orthogonal. However, local inconsistencies introduced at a finite number of lower dimensional surfaces do not necessarily degrade global accuracy. The use of TPFA at faults leads to localized errors that are generally acceptable. Modeling errors associated with alteration or removal of faults are removed at the expense of potentially introducing localized discretization errors. Multipoint flux approximation methods and other consistent discretization schemes could prove useful for treating cut cells and refinement interfaces more accurately. The polyhedral data structure is convenient for implementation of consistent discretization schemes because it describes the geometry and topology completely. The benefits of accurately representing fault geometry and capturing geologically consistent contacts across faults typically outweigh any challenges associated with numerical discretization.

The present invention lends itself to more tightly integrated interdisciplinary workflows. It utilizes the conversion of GeoChron earth models into flow simulation grids with minimal loss of information and added control over resolution. However, if the resolution of the simulation grid is chosen to match the earth model exactly, then the earth model and the resulting cut-cell grid will be almost indistinguishable visually. It is desired that the transition from earth modeling workflows to flow simulation workflows be smooth for users despite the fact that numerical representations are being changed in the background. While cut-cell grids have been designed to improve the transition from earth modeling to flow simulation, they may ultimately prove more valuable when information is transferred in the opposite direction. Because the details of the reservoir structure and stratigraphy are preserved in the simulation grids, it is anticipated that flow results can be more easily interpreted and attributed to specific earth model features.

The compression strategy for polyhedral grids has reduced the memory footprint of the halfedge data structure by around 80%, and has enabled the use of unstructured grids within practical workflows. The approach for generating cut-cell grids from implicitly defined GeoChron models has successfully determined water-tight geometries for a number of challenging examples. In particular, the welding procedure that computes explicit contact polygons across faults has proven to be robust. When combined with a GeoChron earth model representation, the cut-cell grids enable accurate and consistent representation of complex reservoir structure and stratigraphy. The high degree of orthogonality achieved in the cut-cell gridding examples suggests that they are well suited for flow simulation. The flow simulation examples show that cut-cell grids can be combined with structured, flow-based upscaling techniques and can lead to stable multiphase simulations.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

While in the foregoing specification this invention has been described in relation to certain preferred embodiments thereof, and many details have been set forth for the purpose of illustration, it will be apparent to those skilled in the art that the invention is susceptible to alteration and that certain other details described herein can vary considerably without departing from the basic principles of the invention. For example, while embodiments of the present disclosure are described with reference to block diagrams and/or operational illustrations of methods, systems, and computer program products, the functions/acts described in the figures may occur out of the order (i.e., two blocks shown in succession may in fact be executed substantially concurrently or the blocks may sometimes be executed in the reverse order).

All references cited herein are incorporated by reference in their entirety.

What is claimed is:

1. A computer-implemented method for generating a grid used for modeling the behavior of a subsurface reservoir, the computer-implemented method comprising:
(a) providing an earth model of a subsurface reservoir, the earth model comprising an unstructured tetrahedral grid defining a plurality of tetrahedral cells that conform to one or more geological discontinuities, the tetrahedral cells defining vertices in a physical space that store information associated with a depositional space of the subsurface reservoir;
(b) generating a polyhedral grid in the physical space from the unstructured tetrahedral grid, the polyhedral grid defining a plurality of polyhedral cells that are split based on the information associated with the depositional space, one or more of the plurality of polyhedral cells can be associated with one or more elements having split-property values that correspond to properties on opposite sides of the one or more geological discontinuities; and
(c) modeling the behavior of the subsurface reservoir using the polyhedral grid.

2. The computer-implemented method of claim 1, wherein the one or more elements having split-property values are selected from nodes, edges, and contact polygons.

3. The computer-implemented method of claim 1, wherein the information associated with the depositional space stored by the vertices of the tetrahedral cells comprises discrete {u,v,w} values where u and v represent a geographic location at a time of deposition and w represents the time of deposition.

4. The computer-implemented method of claim 1, wherein at least a portion of the polyhedral cells on the updated polyhedral grid positioned away from the one or more geological discontinuities are hexahedral, substantially orthogonal, arranged in a structured manner, and have been refined or coarsened.

5. The computer-implemented method of claim 1, further comprising updating polyhedral grid prior to modeling the behavior of the subsurface reservoir by performing at least one of the following:
merging two or more of the plurality of polyhedral cells; and
splitting one or more of the plurality of polyhedral cells along an iso-value surface of a property.

6. The computer-implemented method of claim 1, wherein generating the polyhedral grid in the physical space from the unstructured tetrahedral grid further comprises:
(1) converting the unstructured tetrahedral grid to a polyhedral data structure, thereby generating a polyhedral grid that comprises a plurality of polyhedral cells that correspond to the tetrahedral cells of the unstructured tetrahedral grid;
(2) welding vertices and polygons of the plurality of polyhedral cells that are co-located while preserving split-property values;
(3) splitting one or more of the plurality of polyhedral cells along an iso-value surface associated with the depositional space of the subsurface reservoir; and
(4) merging adjacent polyhedral cells that share discrete {u,v,w} values.

7. The computer-implemented method of claim 1, wherein generating the polyhedral grid in the physical space from the unstructured tetrahedral grid comprises:
(1) generating a Cartesian grid associated with the depositional space of the subsurface reservoir, the Cartesian grid being unfolded and unfaulted and defining a plurality of Cartesian cells in a depositional coordinate system {u,v,w}; and
(2) intersecting the tetrahedral cells with the Cartesian cells to produce the polyhedral grid defining the plurality of polyhedral cells.

8. The computer-implemented method of claim 7, wherein geometric operations are applied to modify the Cartesian grid prior to intersecting the tetrahedral cells with the Cartesian cells, the geometric operations comprising anisotropic refinement or anisotropic coarsening.

9. The computer-implemented method of claim 7, further comprising updating the polyhedral grid by merging two or more of the plurality of polyhedral cells and forming contact polygons between polyhedral cells that are adjacent to the one or more geological discontinuities.

10. The computer-implemented method of claim 9, wherein updating the polyhedral grid further comprises merging two or more of the contact polygons that are shared by the polyhedral cells that are in contact.

11. The computer-implemented method of claim 9, wherein the merging two or more of the plurality of polyhedral cells comprises at least one of the following:
merging adjacent cells in the polyhedral grid that originate from a common Cartesian cell; and
merging polyhedral cells with a neighboring polyhedral cell if a ratio of the intersected Cartesian cell volume in the depositional space to the Cartesian cell volume prior to intersection is less than a predetermined threshold.

12. The computer-implemented method of claim 9, wherein forming contact polygons between polyhedral cells that are adjacent to one or more geological discontinuities comprises pairing polyhedral cells that are on opposite sides of the one or more geological discontinuities and modifying the faces of the polyhedral cells to reflect this pairing.

13. The computer-implemented method of claim 9, wherein forming contact polygons between polyhedral cells that are adjacent to one or more geological discontinuities comprising a welding operation, the welding operation comprising:
(1) projecting interfaces of the polyhedral cells associated with the one or more geological discontinuities onto coordinate planes of a physical coordinate system {x,y,z};
(2) projecting edges of the polyhedral cells onto the coordinate lines of the physical coordinate system {x,y,z};
(3) forming segments that honor the interfaces of the polyhedral cells associated with both sides of the one or more geological discontinuities, the segments being formed based on the relative position of vertices associated with edges of the interfaces and by computing intersection points interior of the interfaces where edges intersect such that the intersection points define end points for the segments; and
(4) forming the contact polygons utilizing at least one of the segments.

14. A system for generating a grid used for modeling the behavior of a subsurface reservoir, the system comprising:
a database configured to store an earth model of a subsurface reservoir, the earth model comprising an unstructured tetrahedral grid defining a plurality of tetrahedral cells that conform to one or more geological discontinuities, the tetrahedral cells defining vertices in a physical space that store information associated with a depositional space of the subsurface reservoir;
a computer processor configured to receive the earth model from the database, and to execute computer readable software instructions; and
a software program executable on the computer processor, the software program containing a gridding module having computer-readable software instructions to generate a polyhedral grid in the physical space from the unstructured tetrahedral grid, the polyhedral grid defining a plurality of polyhedral cells that are split based on the information associated with the depositional space, one or more of the plurality of polyhedral cells can be associated with one or more elements having split-property values that correspond to properties on opposite sides of the one or more geological discontinuities.

15. The system of claim 14, wherein the database utilizes a compressed halfedge data structure that comprises arrays of elements and halfedges.

16. The system of claim 14, wherein the database utilizes a compressed halfedge data structure that comprises an elements list that stores global identifiers for vertices, edges and polygons incident to each polyhedral cell and a minimal halfedge list that stores local identifiers for vertices and edges that point to the elements list.

17. The system of claim 14, wherein generating the polyhedral grid in the physical space from the unstructured tetrahedral grid comprises:
(1) converting the unstructured tetrahedral grid to a polyhedral data structure, thereby generating a polyhedral grid that comprises a plurality of polyhedral cells that correspond to the tetrahedral cells of the unstructured tetrahedral grid;
(2) welding vertices and polygons of the plurality of polyhedral cells that are co-located while preserving split-property values;
(3) splitting one or more of the plurality of polyhedral cells along an iso-value surface associated with the depositional space of the subsurface reservoir; and
(4) merging adjacent polyhedral cells that share discrete {u,v,w} values.

18. The system of claim 14, wherein generating the polyhedral grid in the physical space from the unstructured tetrahedral grid comprises:
(1) generating a Cartesian grid associated with the depositional space of the subsurface reservoir, the Cartesian grid being unfolded and unfaulted and defining a plurality of Cartesian cells in a depositional coordinate system {u,v,w};
(2) intersecting the tetrahedral cells with the Cartesian cells to produce the polyhedral grid defining the plurality of polyhedral cells; and
(3) updating the polyhedral grid by merging two or more of the plurality of polyhedral cells and forming contact polygons between polyhedral cells that are adjacent to the one or more geological discontinuities.

19. The system of claim 18, wherein forming contact polygons between polyhedral cells that are adjacent to the one or more geological discontinuities comprising a welding operation, the welding operation comprising:
(1) projecting interfaces of the polyhedral cells associated with the one or more geological discontinuities onto coordinate planes of a physical coordinate system {x,y,z};
(2) projecting edges of the polyhedral cells onto the coordinate lines of the physical coordinate system {x,y,z};
(3) segments are formed that honor the interfaces of the polyhedral cells associated with both sides of the one or more geological discontinuities, the segments being formed based on the relative position of vertices associated with edges of the interfaces and by computing intersection points interior of the interfaces where edges intersect such that the intersection points define end points for the segments; and
(4) forming the contact polygons utilizing at least one of the segments.

20. A non-transitory processor readable medium containing computer-readable software instructions for generating a grid used for modeling the behavior of a subsurface reservoir, the computer-readable software instructions having instructions to:
obtain information from a database storing an earth model of a subsurface reservoir, the earth model comprising an unstructured tetrahedral grid defining a plurality of tetrahedral cells that conform to one or more geological discontinuities, the tetrahedral cells defining vertices in a physical space that store information associated with a depositional space of the subsurface reservoir; and
generate a polyhedral grid in the physical space from the unstructured tetrahedral grid, the polyhedral grid defining a plurality of polyhedral cells that are split based on the information associated with the depositional space, one or more of the plurality of polyhedral cells can be associated with one or more elements having split-property values that correspond to properties on opposite sides of the one or more geological discontinuities.
